(19) United States
(12) Patent Application Publication
(10) Pub. No.: US 2010/0277711 A1
(43) Pub. Date: Nov. 4, 2010

(54) OPTICAL QUANTIZED DISTANCE MEASURING APPARATUS AND METHOD THEREOF

(75) Inventors: Cheng-Chung Shih, Fremont, CA (US); Yuh-Min Lin, San Ramon, CA (US)

Correspondence Address: Wang Law Firm, Inc., 4989 Peachtree Parkway,, Suite 200, Norcross, GA, 30092, US

(73) Assignee: CAPELLA MICROSYSTEMS, CORP., Road Town (VG)

(21) Appl. No.: 12/435,081

(22) Filed: May 4, 2009

(51) Int. Cl. G01C 3/08

(52) U.S. Cl. 356/4.01

(57) ABSTRACT

The present invention discloses an optical quantized distance measuring apparatus and a method thereof. The optical distance quantized measuring apparatus comprises an illuminating module, a sensing component array and a processing module. The illuminating module projects a light source onto an object to generate a reflecting light. The sensing component array receives the reflecting light, which generates a light source location on the sensing component array. The processing module determines the light source location, and determines an interval between the object and the sensing component array according to the light source location. The processing module determines the light source location with the binary search algorithm.

### FIELD OF THE INVENTION

The present invention is related to an optical quantized distance measuring apparatus and a method thereof, and more particularly to an optical quantized distance measuring apparatus and a method thereof which can avoid inaccurate measurement results caused from different object reflecting rate.

### BACKGROUND OF THE INVENTION

With the progress of science and technology, optical distance measuring apparatus is gradually used in daily life. At present, optical distance measuring apparatus is divided into the short distance measuring type and the long distance measuring type. The current short distance optical measuring apparatus, for example, is usually applied in a parking distance control of automobile, a paper size detection in copy machine, an anti-collision detection system, a burglary-resistant system, an automatic water filling system of bathroom equipment, a dryer, or a customer entering notification system in a shop.

FIG. 1 illustrates a schematic diagram of an optical distance measuring apparatus in prior art. The optical distance measuring apparatus comprises a light emitting diode (LED) module 11, a sensing module 12 and a processing module (not shown in the drawing). During the measurement of the distance, LED module 11 projects a light 111 onto an object 13 which then generates a reflecting light 112 correspondingly, and the sensing module 12 subsequently receives the reflecting light 112 and the processing module then determines the intensity of the reflecting light 112, so as to calculate the distance between the object 13 and the optical distance measuring apparatus.

However, the defect of the optical distance measuring apparatus in prior art is that the intensity of light source detected by the sensing module 12 constitutes non-linear relationship with the distance of the object 13 due to various light reflecting rate of object. For example, if the color of an object is black, most of light is absorbed by the object 13, only a little light is reflected to the sensing module 12, and this causes inaccurate determination of the processing module, so that the actual distance of the object 13 can not be obtained.

### SUMMARY OF THE INVENTION

In view of said problem of prior art, the object of the present invention is to provide an optical quantized distance measuring apparatus and a method thereof, so as to solve the problem of being unable to measure a distance accurately because of different reflecting rates of objects.

According to the object of the present invention, the inventor discloses an optical quantized distance measuring apparatus comprising an illuminating module, a sensing component array and a processing module. The illuminating module projects a light onto an object, and the object reflects the light to generate a reflecting light. The sensing component array receives the reflecting light, and generates a light source location on the sensing component array. The processing module determines the light source location, and determines an interval between the object and the sensing component array according to the light source location.

Preferably, the processing module determines the light source location by a binary search algorithm.

Besides, the present invention further discloses an optical quantized distance measuring method, which is applied in an optical distance measuring apparatus comprising an illuminating module, a sensing component array and a processing module. The sensing component array is defined a central axis. The optical quantized distance measuring method comprises the following steps. First, the illuminating module is used to project a light source onto an object, and the object rejects the light to generate a reflecting light which is projected onto the sensing component array to form a light source location. And then, the processing module determines the light source location by the binary search algorithm, and finally calculates the distance between the sensing component array and the object according to the light source location.

As the above mentioned content, the optical quantized distance measuring apparatus and the method thereof of the present invention use the processing module to determine the light source location on the sensing component array by a binary search algorithm, and calculate the distance between the sensing component array and the object according to the light source location, so as to solve the problem of determining the distance of the object depending on the intensity of reflected light, and generating measurement deviation due to different reflecting rates of objects.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a schematic diagram of the optical quantized distance measuring apparatus in the prior art;

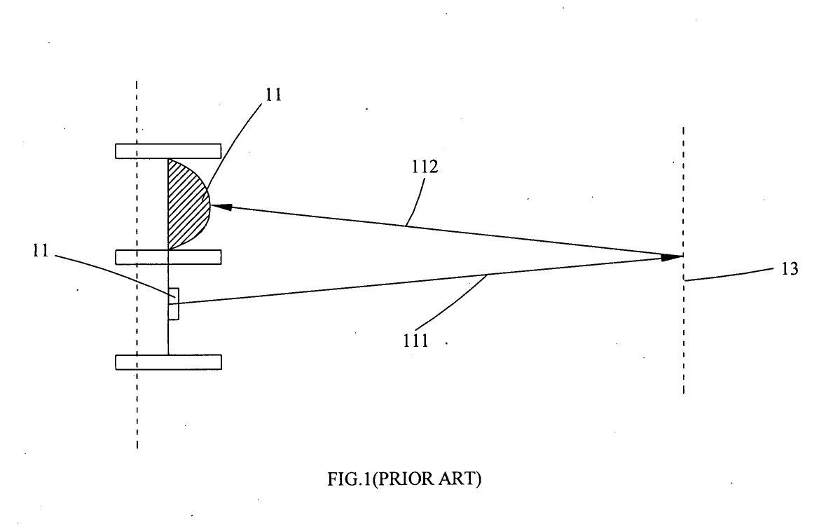

FIG. 2 is a schematic diagram of an embodiment of the optical quantized distance measuring apparatus of the present invention;

FIG. 3 is a schematic diagram of the sensing component array of the optical quantized distance measuring apparatus of the present invention;

FIG. 4 is a flow chart of the optical quantized distance measuring method of the present invention;

FIG. 5 is a schematic diagram of embodiment 1 of the binary search algorithm of the optical quantized distance measuring method of the present invention;

FIG. 6 is a schematic diagram of embodiment 2 of the binary search algorithm of the optical quantized distance measuring method of the present invention;

FIG. 7 is a cycle oscillogram generated by the reflecting light which determines the light source location of the present invention;

FIG. 8 is a flow chart generated by the reflecting light which determines the light source location of the present invention;

FIG. 9 is a timing schematic diagram of the optical quantized distance measuring method of the present invention;

FIG. 10 is a block diagram of the optical quantized distance measuring apparatus of the present invention.

### DETAILED DESCRIPTION

Exemplary embodiments of the present invention are described herein in the context of an optical quantized distance measuring apparatus and method thereof.

Those of ordinary skilled in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

In accordance with the embodiment(s) of the present invention, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

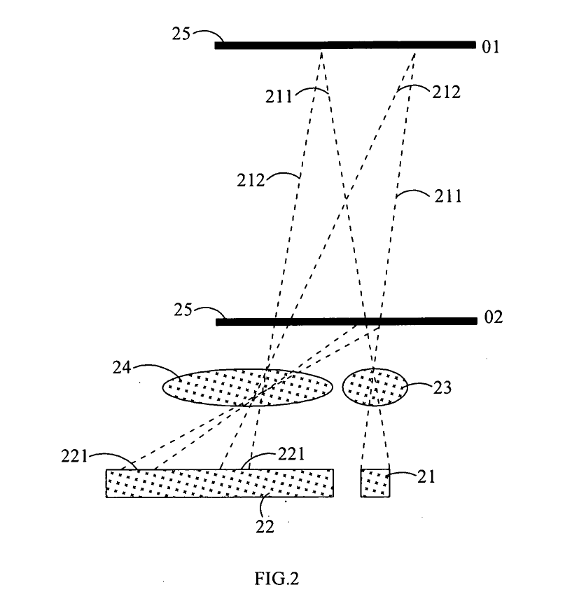

FIG. 2 illustrates a schematic diagram of an embodiment of an optical quantized distance measuring apparatus of the present invention, the optical quantized distance measuring apparatus comprises an illuminating module 21, a sensing component array 22, a first lens 23, a second lens 24 and a processing module (not shown in the drawing).

During the measurement of the distance between an object 25 and an optical measuring apparatus, the illuminating module 21 is used to project a light 211, which is focused by the first lens 23, and then projected onto the object 25. The object 25 then reflects the light 211 to generate a reflecting light 212. The reflecting light 212 is focused by the second lens 24 and projected onto the sensing component array 22, so that the light source location 221 is generated on the sensing component array 22. The processing module executes a binary search algorithm to determine the light source location 221. As the distance between the object 25 and the sensing component array 22 varies, the light source locations 221 projected onto the sensing component array 22 are different, so the processing module can calculate the distance between the object 25 and the sensing component array 22 according to the light source locations 221.

The illuminating module 21 is a light source with visible or invisible light. The sensing component array 22 is preferred to be a photodiode array having length of 2300 um which depends on the designed detection distance requirement. The sensing component array can convert the received light into a corresponding voltage signal.

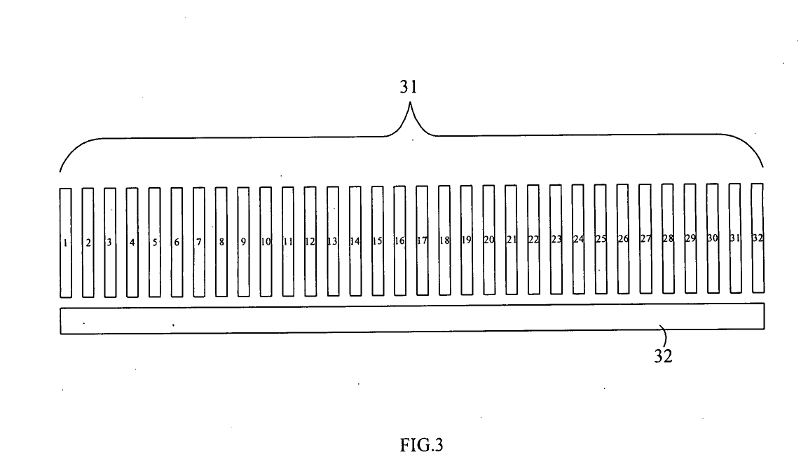

FIG. 3 illustrates a schematic diagram of the sensing component array of the embodiment of the optical quantized distance measuring apparatus of the present invention. In order to prevent the situation that the object is located infinitely far away from the sensing component array, or the light source location of the reflecting light is located at the central axis of the sensing component array, and the processing module can not determine the actual distance of the object, the optical quantized distance measuring apparatus of the present invention further comprises a monitor PD module 32. When the monitor PD module 32 receives the light with intensity of the voltage value smaller than a first voltage threshold A, it means that the object is located infinitely far away from the sensing component array or the monitor PD module 32 receives the interference noise. When the voltage value of intensity of received light is larger than a second voltage threshold B larger than A, it means that the monitor PD module reaches saturation detection value, and is unable to detect. When the voltage value of intensity of received light is between A and B, the processing module determines such voltage value as an effective value and executes the further process. If the voltage value is larger than B or smaller than A, then the processing module determines the voltage value as a non-effective value and discards it. In the drawing, the sensing component array 31 comprises totally 32 photodiodes, such as photodiode 1 to 32. The photodiode 1 to 8, and photodiode 25 to 32 are dummy photodiodes for only assisting the processing module and not detecting the reflecting light. In the present invention, the sensing component array can be realized by 32 photodiodes, but this is not a limitation.

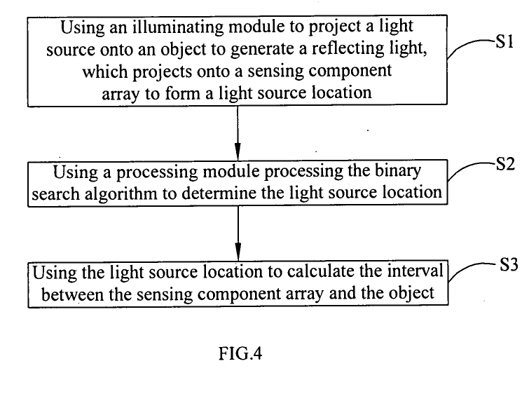

FIG. 4 illustrates a flow chart of the optical quantized distance measuring method, which is applicable to an optical apparatus having an illuminating module, a sensing component array and a processing module. The method comprises the following steps. In step S1, the illuminating module is used to project a light onto an object, and the object reflects the light to emit a reflecting light, which projects onto a sensing component array to form a light source location. In step S2 the processing module executes a binary search algorithm to determine the light source location. In step S3 the light source location is used to calculate the distance between the sensing component array and the object.

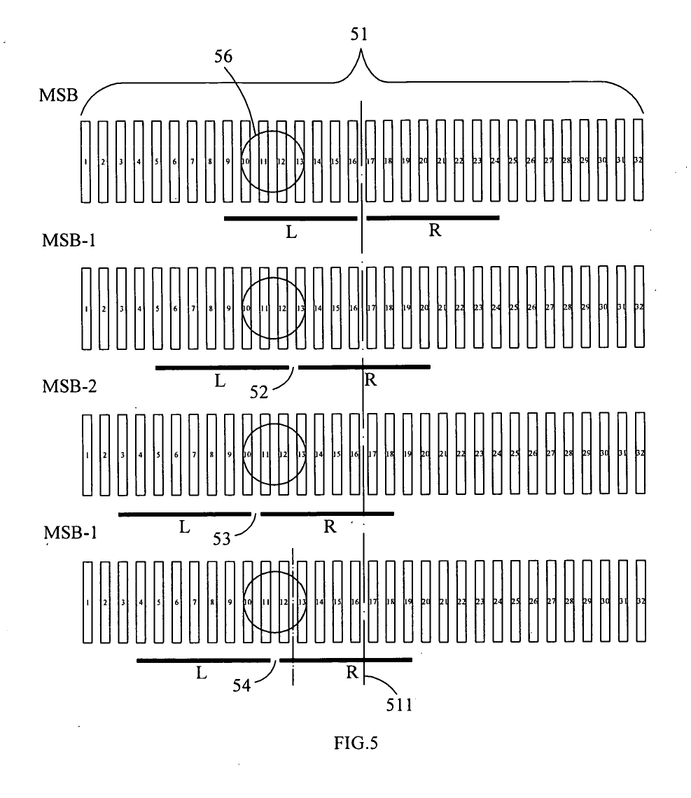

FIG. 5 illustrates a schematic diagram of first embodiment of the binary search algorithm of the optical quantized distance measuring method of the present invention. The sensing component array 51 is defined a central axis 511, and the binary search algorithm is realized by the following steps. First, the total light intensity of 8 left photodiodes of the central axis 511 is compared with the total light intensity of 8 right photodiodes of the central axis 511. In the embodiment, because the total light intensity of the left is stronger than that of the right, a first positioning location 52 which shifts toward the left by an interval of 4 photodiodes and a first shift signal are generated.

Then, the total light intensity of 8 left photodiodes of the first positioning location 52 is compared with the total light intensity of 8 right photodiodes of the first positioning location 52. In the embodiment, because the total light intensity of the left side is stronger than that of the right side, a second positioning location 53 which shifts toward the left for an interval of 2 photodiodes and a second shift signal are generated.

Sequentially, the total light intensity of 8 left photodiodes of the second positioning location 53 is compared with the total light intensity of 8 right photodiodes of the second positioning location 53. In the embodiment, because the total light intensity of the right is stronger than that of the left, a third positioning location 54 which shifts toward the right for an interval of 1 photodiode and a third shift signal are generated.

Finally, the total light intensity of 8 left photodiodes of the third positioning location 54 is compared with the total light intensity of 8 right photodiodes of the third positioning location 54. In the embodiment, the total light intensity of the right is stronger than that of the left.

Preferably, the said first shift signal is the most significant bit (MSB), the second shift signal is MSB-1, the third shift signal is MSB-2, and the fourth shift signal is the least significant bit (LSB). The first shift signal, the second shift signal, the third shift signal, and the fourth shift signal can be represented as “0” or “1”. In the embodiment, if total light intensity of the left side is stronger than that of the right side, then the shift signal is “0”; if the total light intensity of the right side is stronger than that of the left side, then the shift signal is “1”. For example, the first shift signal, the second shift signal, the third shift signal, and the fourth shift signal in the embodiment can be arranged by the sequence of “0011”. The processing unit can use the signals of “0011” to determine the light source location 56 located on sensing component array 51.

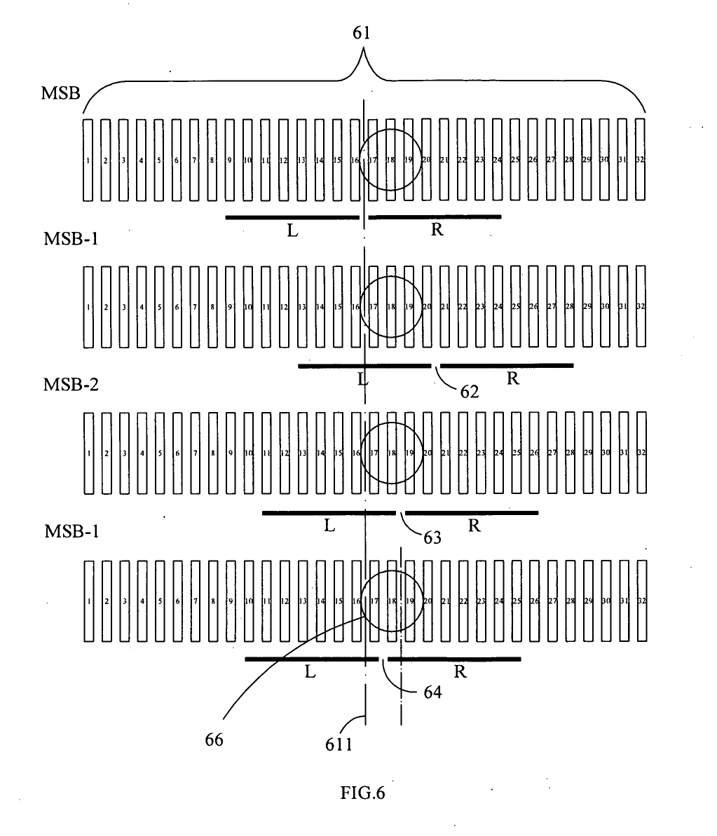

FIG. 6 illustrates a schematic diagram of the second embodiment of the binary search algorithm of the optical quantized distance measuring method of the present invention, the binary search algorithm is realized by the following steps. First, the total light intensity of 8 photodiodes at left side of the central axis 611 is compared with the total light intensity of 8 photodiodes at right side of the central axis 611. In the embodiment, because the total light intensity of the right is stronger than that of the left, a first positioning location 62 which shifts toward the right for an interval of 4 photodiodes and a first shift signal are generated.

Then, the total light intensity of 8 photodiodes at left side of the first positioning location 62 is compared with the total light intensity of 8 photodiodes at right side of the first positioning location 62. In the embodiment, because the total light intensity of the left side is stronger than that of the right side, a second positioning location 63 which shifts toward the left for an interval of 2 photodiodes and a second shift signal are generated.

Sequentially, the total light intensity of 8 photodiodes at left side of the second positioning location 63 is compared with the total light intensity of 8 photodiodes at right side of the second positioning location 63. In the embodiment, because the total light intensity of the left side is stronger than that of the right side, a third positioning location 64 which shifts toward the left for an interval of 1 photodiode and a third shift signal are generated.

Finally, the total light intensity of 8 photodiodes at left side of the third positioning location 64 is compared with the total light intensity of 8 photodiodes at right side of the third positioning location 64. In the embodiment, the total light intensity of the right is stronger than that of the left. In the present embodiment, the first shift signal, the second shift signal, the third shift signal and the fourth shift signal are arranged as “1001” in order. The processing unit reads the signals of “1001” to determine the light source location 66 located on sensing component array 61.

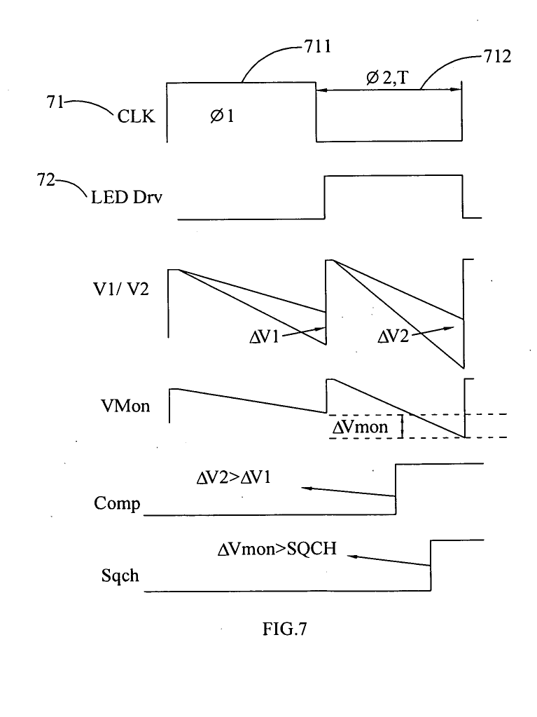

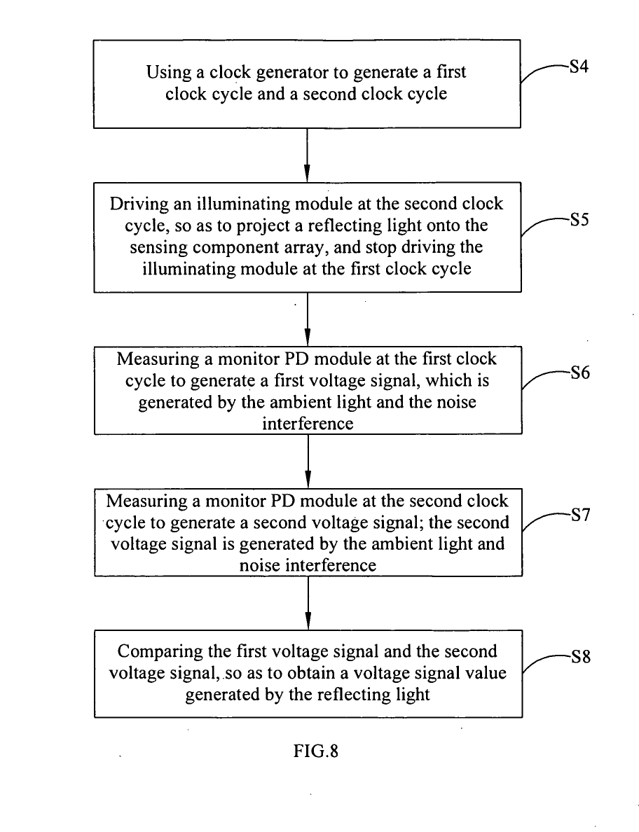

FIG. 7 and FIG. 8 illustrate respectively a cycle oscillogram and a flow chart of a method of determining the light source generated by the reflecting light of the present invention. In order to prevent the sensing component array from being interfered by the ambient light and the noise interference, thereby causes the processing module to be unable to determine the light source location located on the sensing component array correctly, the following steps are used to calibrate the light source location. In step S4, a clock generator 71 is use to generate a first clock cycle 711 and a second clock cycle 712. In step S5, an illuminating module 72 is driven to project a reflecting light onto the sensing component array at the second clock cycle 712, and stop projecting the reflecting light at the first clock cycle 711.

In step S6, a monitor PD module is measured at the first clock cycle to generate a first voltage signal, which is generated by the ambient light and the noise interference. In step S7, then, the monitor PD module is measured at the second clock cycle to generate a second voltage signal, and the second voltage signal is generated by the ambient light and noise interference. Finally, in step S8 the first voltage signal is compared with the second voltage signal, so as to obtain a voltage value generated by the reflecting light.

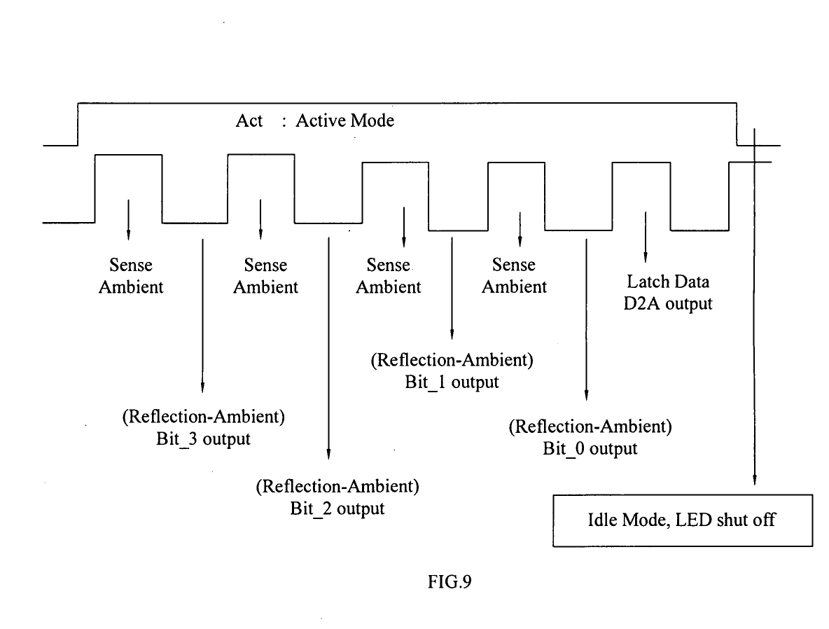

FIG. 9 illustrates a tuning diagram of the optical quantized distance measuring method of the present invention. As shown in the FIG. 9, before running the binary search algorithm, the processing module executes a procedure to correct the ambient light and noise interference first, so as to obtain the actual voltage value generated by the reflecting light.

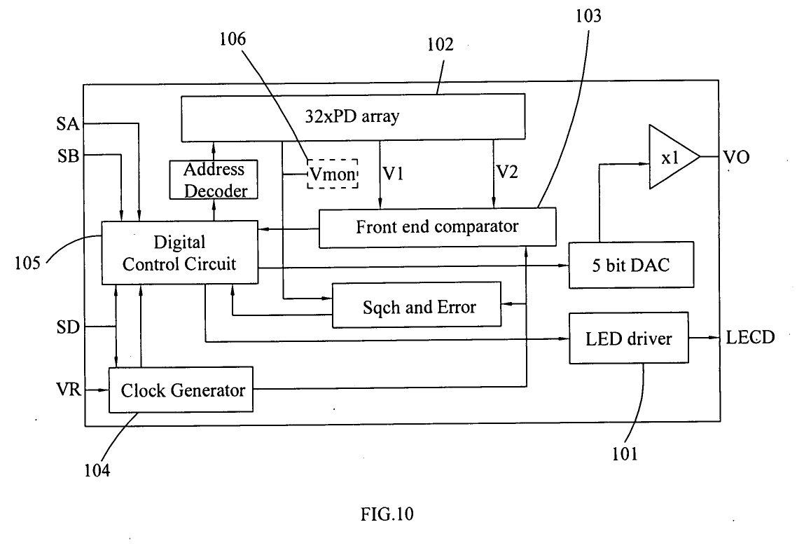

Referring to both FIG. 7 and FIG. 10 which illustrates a block diagram of the optical quantized distance measuring apparatus of the present invention. In the FIG. 10, the LED driver 101 is used to emit a light source to an object, and the PD array 102 is used to detect the reflecting light which is generated by the projection of LED driver onto the object. Front end comparator 103 is capable of comparing the voltage value of the left photodiode and that of the right photodiode. The clock generator 104 is capable of generating a first clock cycle and the second clock cycle. The digital control circuit 105 is used to receive each pin signal, clock signal, and the compared result of the front end comparator 103, and uses them to perform the binary search algorithm, and then output the operation result, and Δ Vₘₒₙ 106 is detected as the voltage value actually generated by the reflecting light to the monitor PD module.

As the abovementioned contents, the effect of the optical quantized distance measuring apparatus and the method thereof of the present invention lies in using the sensing component array to detect the reflecting light, and using the processing module to calculate the light source location located on the sensing component array by operating the binary search algorithm, and calculate the interval between the object and the sensing component array according to the light source location.

The abovementioned contents are just for examples, not for limitations. Any equivalent modification and verification which are not beyond the spirit and scope of the present invention should be comprised in the following attached claims.

What is claimed is:

1. An optical quantized distance measuring apparatus, comprising:
an illuminating module capable of emitting a light onto an object for obtaining a reflecting light;
a sensing component array capable of receiving the reflecting light, and the reflecting light being projected on a light source location on the sensing component array; and
a processing module capable of determining the light source location and determining the distance between the object and the sensing component array.

2. The optical quantized distance measuring apparatus of claim 1, wherein the processing module uses binary search algorithm to determine the light source location.

3. The optical quantized distance measuring apparatus of claim 1, further comprising a monitor PD module capable of determining whether the distance is infinitely great.

4. The optical quantized distance measuring apparatus of claim 3, wherein the sensing component array is defined a central axis, and the monitor PD module determines whether the light source location is located on the central axis.

5. The optical quantized distance measuring apparatus of claim 1, wherein the sensing component array is a photodiode array.

6. The optical quantized distance measuring apparatus of claim 2, further comprising a comparator and a digital control circuit for performing the binary search algorithm.

7. An optical quantized distance measuring method, applicable to an optical quantized distance measuring apparatus having an illuminating module, a sensing component array and a processing module, wherein the sensing component array is defined a central axis, and the optical quantized distance measuring method comprises the steps of:
using the illuminating module to emit a light on an object for obtaining a reflecting light, and the reflecting light being projected on a light source location on the sensing component array;
using the processing module to determine the distance between the sensing component array and the object according to a binary search algorithm and the central axis.

8. The optical quantized distance measuring method of claim 7, wherein the binary search algorithm is operated with a comparator and a digital control circuit.

9. A method of determining the light source location generated by the reflecting light applicable to the method of claim 7, comprising the steps of:
providing a first clock cycle and a second clock cycle;
driving the illuminating module at the second clock cycle, and allowing the reflecting light projecting onto the sensing component array;
stopping driving the illuminating module at the first clock cycle;
measuring a monitor PD module at the first clock cycle to generate a first voltage signal;
measuring the monitor PD module at the second clock cycle to generate a second voltage signal; and
comparing the first voltage signal and the second voltage signal to obtain a voltage value generated by the reflecting light.

10. The method of determining the light source location generated by the reflecting light of claim 9, wherein the first voltage signal is generated by an ambient light and noise interference.

11. The method of determining the light source location generated by the reflecting light of claim 9, wherein the second voltage signal is generated by the ambient light noise interference, and the reflecting light.
